(19) United States
(12) Patent Application Publication
(10) Pub. No.: US 2009/0250375 A1
(43) Pub. Date: Oct. 8, 2009

(54) PRODUCT DISPLAY SYSTEM AND METHOD

(76) Inventor: William David Ecker, Stamford, CT (US)

Correspondence Address: STROOCK & STROOCK & LAVAN LLP, 180 MAIDEN LANE, NEW YORK, NY, 10038, US

(21) Appl. No.: 12/418,289

(22) Filed: Apr. 3, 2009

Related U.S. Application Data
(60) Provisional application No. 61/042,452, filed on Apr. 4, 2008.

(51) Int. Cl. B65D 5/52; A01K 29/00

(52) U.S. Cl. 206/736; 119/28.5

(57) ABSTRACT

A display system is provided for shipping products to a retail location and displaying those products, such as pet beds. The display system and the products to be displayed can be shipped and displayed in a single container. In a preferred embodiment of the invention, the container can convert from a shipping box to a combined storage and display system. Systems in accordance with the invention help optimize the use of retail floor space. They can also help insure that products are displayed as the manufacturer intended. Systems in accordance with the invention can also reduce waste. In one preferred embodiment of the invention, the container is in the form of a box comprising cardboard, corrugated paper or other relatively inexpensive material that can hold its shape and can be easily disposed of.

### CROSS REFERENCE TO RELATED APPLICATIONS

This application claims the benefit of U.S. Provisional Patent Application Ser. No. 61/042,452, filed Apr. 4, 2008, the entire contents of which is incorporated herein by reference.

### BACKGROUND OF INVENTION

The invention relates generally to a display system and more particularly to a system for displaying, housing and/or storing one or more items.

Retail stores are often faced with the conflict of apportioning storage space versus space dedicated to the sales floor where customers can roam. Goods are often packed for transport in the most cost effective manner. When displayed for sale, however, good are often displayed in what is typically a much more aesthetic manner. Thus, floor space is typically split between storage areas for receiving and storing goods in their shipping containers and the sale floor where they are displayed in a more pleasing environment conducive to shopping.

Accordingly, it has been determined that it is desirable to provide a system for overcoming drawbacks in conventional systems for shipping, storing and displaying goods that helps eliminate the distinction between areas needed for storage and areas needed to display goods for sale.

### SUMMARY OF THE INVENTION

A display system is provided for shipping products to a retail location and displaying those products, such as pet beds, wherein the display system and the products to be displayed can be shipped and displayed in a single container. In a preferred embodiment of the invention, the container can convert from a shipping box to a combined storage and display system. Systems in accordance with the invention help optimize the use of retail floor space. They can also help insure that products are displayed as the manufacturer intended. Systems in accordance with the invention can also reduce waste. In one preferred embodiment of the invention, the container is in the form of a box comprising cardboard, corrugated paper or other relatively inexpensive material that can hold its shape and can be easily disposed of.

The products to be shipped, stored and displayed in systems in accordance with the invention can also be compressed. For example, their volume can be reduced by half or approximately one third or less of the volume otherwise occupied by the uncompressed product. Therefore, the system can provide an increased efficiency in shipping and displaying the product by reducing the packaging required for transport as well as reducing the storage area required to store the products not being displayed.

Also, by providing a display system built for the product being shipped in the container, the manufacturer can control the type, standard, size, etc. of the manner in which the products are displayed and stored. Such a system can also promote product recognition by maintaining a constant style of display throughout various vendors, retailers, regardless of location.

One embodiment of the invention provides a box having flaps that can be folded to create the display, while maintaining many of the products inside the box. By way of non-limiting example, the box can include four top flaps which fold onto themselves to form a display platform above the storage portion of the box containing the products stored therein. The flaps are preferably folded outward and down the external side of the box and secured thereto, for example, via an adhesive, hook, notch and so forth. A display section is preferably included. A display section or portion can be secured over the box, to a side of the box, preferably in an upright position. The display section can be aligned with the sides of the box to which it is attached. The display portion can include one or more, preferably two, side flaps which can be connected to the two adjacent sides of the box, which preferably improves maintaining the adjacent flap in the upright position. Inventory can be stored under the display section and displayed on top of it.

With systems in accordance with certain embodiments of the invention, the box is opened, folded into proper configuration and used as a display. When empty, it can be disposed of, providing a disposable display. Such a display system can significantly reduce cost by eliminating the need for separate shipping containers and display assemblies.

Alternatively, the top of the box can be discarded after opening the box. A separate header can be provided, preferably including a plurality of flaps such that the header can sit on, straddle, or otherwise be attached to the box.

The flaps preferably include graphic design, for example, corresponding to the product being displayed in the box. Thus, if the product is a pet bed that is used in a home, the graphics can suggest a home, depict a home or a part of a home or have some other marketing relationship with the goods to be displayed.

The box is preferably made of a material that is relatively inexpensive. It should be made of easy to dispose of materials, such as cardboard. Once all the products in the box are depleted, the box can be discarded.

Thus, it is an object of the invention to provide a display system that is relatively simple to set up and remove.

It is also an object of the invention to provide a product package system that reduces waste.

Other objects, features, and characteristics of the present invention, as well as the methods of operation and functions of the related elements of the structure, and the combination of parts and economics of manufacture, will become more apparent upon consideration of the following detailed description with reference to the accompanying drawings, all of which form a part of this specification.

### BRIEF DESCRIPTION OF THE DRAWINGS

For a more complete understanding of the present invention, reference is now made to the following drawings in which:

FIG. 1 is a perspective view of a display system in accordance with an embodiment of the invention;

FIG. 2 is a perspective view of a container of a display system in accordance with an embodiment of the invention in a shipping configuration;

FIG. 3 is a perspective view of a container of a display system in accordance with an embodiment of the invention in a display configuration;

FIGS. 4-1 to 4-9 illustrate the various stages of the container during assembly of a display system in accordance with embodiments of the invention; FIG. 4-1 shows how the shipper box can look when it arrives at a store. FIG. 4-2 shows that after the shipper is opened, the inside panels can be used to display graphics. FIG. 4-3 shows all four panels folded down to adhere flat to the outside of the shipper exposing the live graphics area. FIG. 4-4 shows that the insert folds out of the shipper to allow for more area for products and possible graphics panels. FIG. 4-5 shows that the insert has tabs to fit into slots in the side panels and shows that to insert the tab, a user can hold the side panel at a 90° angle and slide both tabs into slots. FIG. 4-6 shows details of the tabs being inserted into the slots. FIG. 4-7 shows that the header can fold up to have the option of an added graphics area. FIG. 4-8 shows that the shipper panels can be folded flush to the outside of the shipper and adhere with the provided double-sided adhesive tape or pads. FIG. 4-8a shows the display ready for retail, with no product on the display area.

FIGS. 5-1 to 5-6 illustrate various stages of the container during assembly of a display system in accordance with another embodiment of the invention. To assemble the system, the header shown in FIG. 5A is removed, unfolded and placed over the box. FIG. 5B shows end tabs on the header that are inserted into the box and middle tabs are inserted outside the box. FIG. 5C shows the top panel unfolded to form the depiction of a roof. FIG. 5D shows a product in a compressed state, restrained in a bag that is cut open to permit the product to expand. FIG. 5E shows the expanded, fluffed up beds of FIG. 5D placed on the display which with additional beds stored in the box.

### DETAILED DESCRIPTION OF THE PREFERRED EMBODIMENTS

Systems in accordance with the invention include a box and individually packaged goods in the box. The box can include a display portion constructed and arranged to be configured into a display configuration. The display portion an be formed by folding out flaps of the box, by including display portions as separate items in the box or combinations of the two. The box is shipped to a retail location that can have a storage area and a customer access area where customers can access items on display. The display portion is arranged into its display configuration and can be placed on or attached to the box. This attachment can be via adhesive, tab and slot attachment or both. some but not all of the individually packaged products are removed from the box and removing them from their individual packages (if any). They are then arranged on the display portion on the box. The box is located in the customer access area of the sales floor. As products are removed from the display portion, additional products from the box are removed and placed on the display portion. When all of the products are gone from the box and the display portion, the box and display portion can be removed from the customer access area. The products can be in a compressed state of less than about 50% of their uncompressed volume and put in their uncompressed state on the display area. In one embodiment of the invention, the products comprise pet beds and the display area depicts at least a portion of a house. The box and display area can be made of cardboard.

Illustrative embodiments of the present invention are disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiments for purposes of disclosure.

The following presents a detailed description of preferred embodiments of the invention.

In one embodiment of the invention, a shipment of product is shipped to a retailer in a shipping box that can be a rectangular shaped box. The dimensions of the box should be optimized to fit the shipping pallet. In one non-limiting embodiment of the invention, the box is 34″×24″×23″. The top panel of the box can be taped, stapled or otherwise retained in place. When it is desired to display the shipped items, the box can be brought to the display floor. The top panel can be pivoted up about 90° along one of its four edges, exposing a front facing side. Up to all four panels can be folded down and adhere flat to the outside of the shipper box, exposing the graphics portion of the display. An optional insert can be removed from the shipper box and unfolded out of the shipper to allow for more area for product and possible graphics panels. The insert preferably includes tabs to couple it via slots with the side panels of the shipper to mount the display portion to the top of the shipper. Inventory can be kept within the shipper until ready to be put on the display section.

In accordance with an exemplary embodiment, the product is compressed prior to shipping, thus increasing the number of products that can fit in the container. Preferably, the products are compressed to a compressed state having a volume of about one half, about one third or less of the volume of the product in the uncompressed state.

A header from the shipper can fold up to provide the option of added graphics area. The shipper panels can be folded flush to the outside of the shipper and adhesive can be used to keep them flat. One or more products can be removed from the container, and, if in the compressed state, some or all the products are preferably uncompressed prior to being displayed.

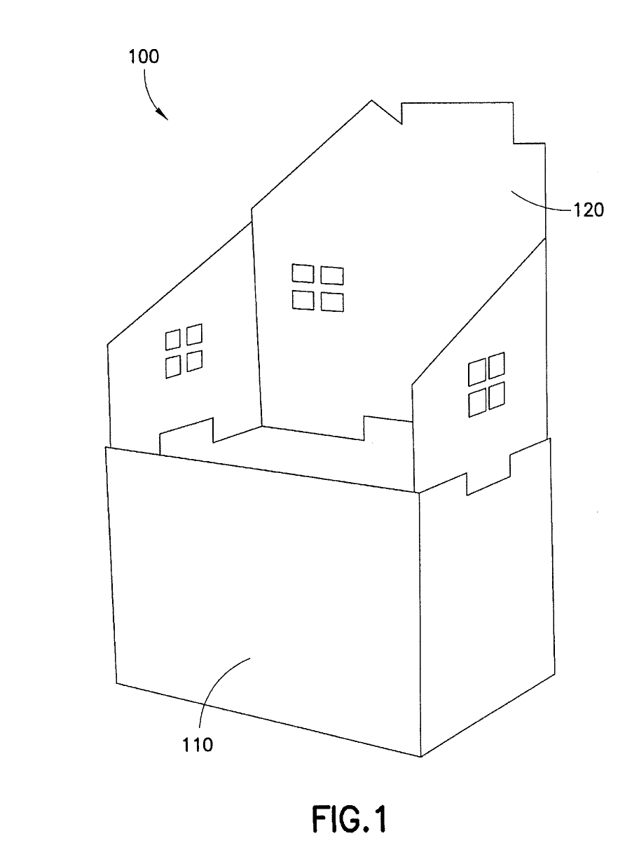

A display system 100 in accordance with and embodiment of the invention is illustrated in FIG. 1, system 100 comprises a container portion 110 suitable for retaining, storing and shipping products. System 100 also includes a display portion 120 which is preferably designed to correspond in some manner to the product being shipped, stored and displayed in display system 100. For example, the display portion 120 can be shaped or include graphic art to provide product logos, product information, complementing graphic art, or other suitable design in accordance with application specific design choice. In the embodiment shown, the display portion 120 is shaped to depict a bedroom portion of a house to correspond to where the product being displayed therein, such as a pet bed, would be used.

Preferably the product is compressed, for example, vacuum compressed and sealed, to a compressed volume of approximately a third of the volume of the product in the uncompressed state. More preferably, the product can be compressed to about 15% of the size of the product in the uncompressed state. Straps, a container, wraps, a bag or other restraining mechanisms can be used to retain the product in the compressed state. A combination of restraining mechanisms can also be used.

In accordance with an embodiment of the invention, the product is a mattress for a pet bed. Preferably, once the retaining device is removed, for example, by taking the mattress out of the container, releasing the straps, etc., the mattress can expand to its natural uncompressed state. In accordance with one embodiment of the invention, the mattress is expanded naturally without the use of an external device. Alternatively, an expanding device may be used. This expanded state is preferably naturally maintained and is further substantially maintained while in use. In accordance with an exemplary embodiment of the invention, the volume of the mattress in the compressed state can be approximately 5 to 50% of the expanded state, more preferably approximately 14 to 30%, most preferably approximately 20 to 25%.

Preferably, the products are packaged in groups, such that one or more groups of products can be opened and displayed at a time, and the remaining groups of products can be maintained, preferably in the compressed state, within container portion 110. Display system 100 can preferably display one group of products at a time. Therefore, once the retailer, vendor, etc. receives display system 100, an employee can set up display system 100 and remove one group of products from container portion 110 and place it in display portion 120 in the uncompressed state. This can help reduce confusion associated with determining how many products to display at a time. Once the first group of products is removed from display portion 120, or if only one product is left, etc. according to the preference of the retailer, vendor, etc., a second group of products can be removed from container portion 110 and placed in display portion 120. This process can be repeated until container portion 110 is depleted of products, after which display system 100 can be discarded, recycled or returned to the vendor for further use.

Once the supply of products of a display system 100 is depleted, it can be replaced with a new display system 100 for the same product, preferably providing the same or similar design in display portion 120. Because display system 100 can be replaced constantly, it does not require extensive maintenance and thus the cost of displaying and storing the products can be reduced. Additionally, display system 100 can encourage product recognition by encouraging various retailers, regardless of size, location, etc. to display the product in a common, uniform manner. Because display system 100 is integrated with container 110 in which the products are shipped, the retailers do not incur any additional cost for displaying the products, and thus the retailers can be encouraged to utilize display system 100 to display the products.

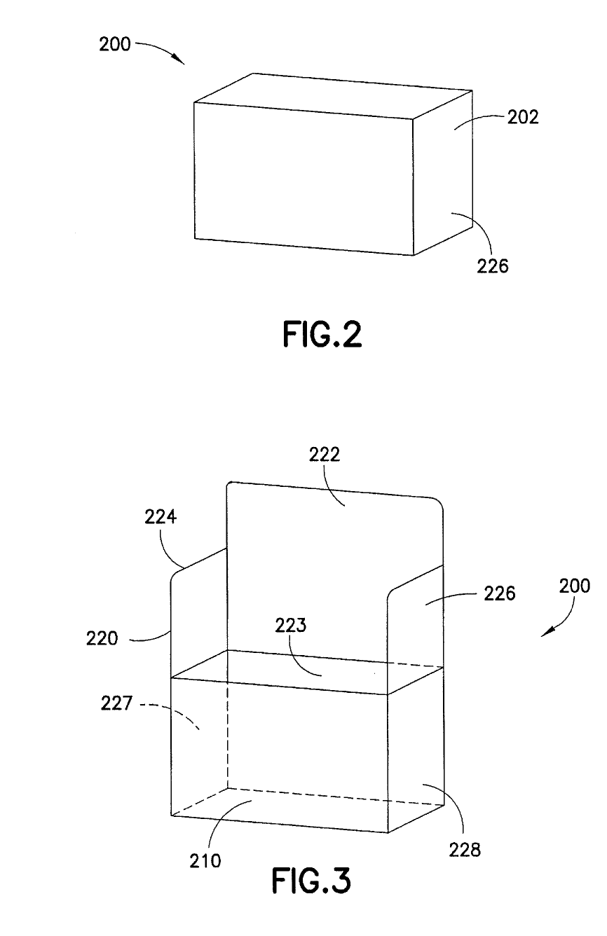

A display system 200 in accordance with another embodiment of the invention is shown in FIGS. 2-3. System 200 includes a container portion 210 for transporting and storing goods and a display portion 220 for displaying such goods for sale. In FIG. 2, display system 200 is shown in a shipping state as a shipper box 202 where it is compact, stackable and efficiently configured for shipment. As shown, display system 200 can be shipped as a unitary item, such as box 202, which preferably includes the products therein plus any trays or display portions to be used with box 202.

FIG. 3 illustrates display system 200 in the displaying state having a display portion 220 extending above and mounted on container portion 210. Display portion 220 preferably includes a rear wall 222 and side walls 224 and 226. Preferably two side walls 224 and 226 are each adjacent to and connected to rear wall 222. Preferably, side walls 224 and 226 are formed integrally with rear wall 222. In one embodiment of the invention, they fold flat against the inside surface of wall 222 in the shipping state of FIG. 2 and fold out to be in the display state of FIG. 3. Rear wall 222 is positioned above and aligned with a rear wall 223, of container portion 210. Side walls 224 and 226 are positioned above and aligned with respective side walls 227 and 228 of container portion 210.

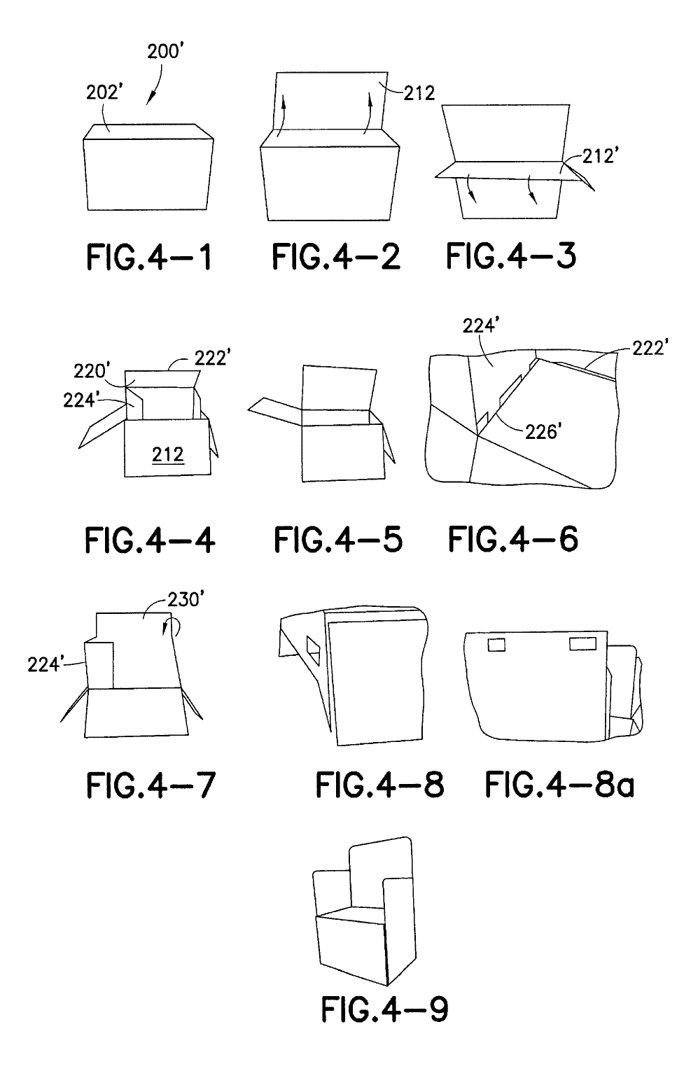

FIG. 4, including FIGS. 4-1 to 4-9, illustrates a method of assembling display system 200′, which is similar to system 200, in accordance with an embodiment of the invention. As shown, display system 200′ can be provided, preferably suitable for shipping, in a self contained box 202′. Box 202′ can be opened by displacing flaps 212′, either by pivoting flaps 212′ away from box 202′ or alternatively, by removing flaps 212′ from box 202′. Flaps 212′ can be pivoted outward from box 300 and attached to the respective wall of box 202′ to which it is connected. Preferably, each flap 212′ and/or its respective wall of box 202′ include adhesives or tabs to attach the flap 212′ to its respective wall of box 202′. In accordance with the embodiment illustrated, each flap 212 can include double side tape affixed thereto, which can attach the flap 212′ to the respective wall of box 300. Box 300 can include four walls and four flaps 212′, each flap 212′ being attached to each wall, thus forming the container portion 210′.

The display portion 220′ is preferably included within box 300 and can be removed therefrom. Each wall 222′, 224′ of the display portion 220′ can thereafter be attached to a wall of the container portion 210′, for example, via a plurality of tabs and recesses. In the embodiment shown, the side walls 224′ of the display portion 220′ includes a plurality of tabs 229′ which can be inserted into the corresponding recess of the corresponding wall of the container portion 210′. Rear wall 222′ of display portion 220′ can also include a plurality of tabs or it can be formed integrally with the corresponding wall of the container portion 210′. Alternatively, one or more walls 222′, 224′ of the display portion 220′ can extend downward and adjacent to the respective wall of container portion 210′ and can be affixed thereto using adhesives or other suitable manner. Another embodiment of display portion 220′ can sit on or straddle container portion 210′.

In the embodiment of the invention shown in FIG. 4, rear wall 222′ includes a header 230′ on which additional design element, such as graphic art, can be provided. For example, the product logo can be provided on the header. Preferably, the product being displayed is included in box 300 during shipping, and can be retained and displayed in container portion 210′. Preferably, additional products can be stacked above the products in the container portion 210′, such that the products are visible and supported by display portion 220′. Accordingly, if additional products are stacked to the height of side walls 224′ of the display portion 220′, the information and graphics or other design provided on header 230′ can remain visible above the products.

In accordance with an alternate embodiment of the invention, a shelf portion can be provided to cover the top of the container portion 210′. Accordingly, the products being displayed can be supported by the shelf portion such that all the products are visibly displayed rather than placed inside the container portion 210′ in which the products may not be as visible. The shelf portion can be included in box 300 or it can be provided independently without deviating from the scope of the invention.

Whereas walls 222′, 224′ of display portion 220′ are shown as being positioned to be aligned with the respective walls of the container portion and at 90 degree angles, it is to be understood that walls 222′, 224′ can be constructed and arranged to be positioned at various angles to the walls of the container portion as well as to each other.

Additionally, display system 200′ preferably comprises a relatively inexpensive material, so that the displayer can discard the display system 200′ once all the products are sold or otherwise removed from the display system 200′. Alternatively, the display system 200′ can be reused, either for the same product or for another product as desired. Non-limiting examples of suitable material for the display system 200′ include cardboard, paper board, and corrugated paper, which are durable enough for shipping and flexible enough for folding and unfolding. Preferably, the material is stiff enough so that the tabs 226′ can retain their shapes and maintain the respective wall 224′ in the desired position with respective to the corresponding wall of the container portion.

In accordance with an embodiment of display system 200′, the top of box 202′ can be removed, and an instruction sheet can be provided inside box 202′ explaining how display system 200′ can be set up. The top of box 202′ that is removed can be discarded, and can have a depth of approximately 1 to 5, or preferably 3 inches. Preferably, display portion 220′ is positioned within the depth, such that the top most product in box 202′ is substantially flush with the top of container portion 210′. Such an arrangement may be preferable to maximize visibility of the product within box 202′. Furthermore, a removable top and a separate display portion 220′ can reduce the amount of material used. For example, the display portion 220′ can be made of a thinner material than desirable for box 202′.

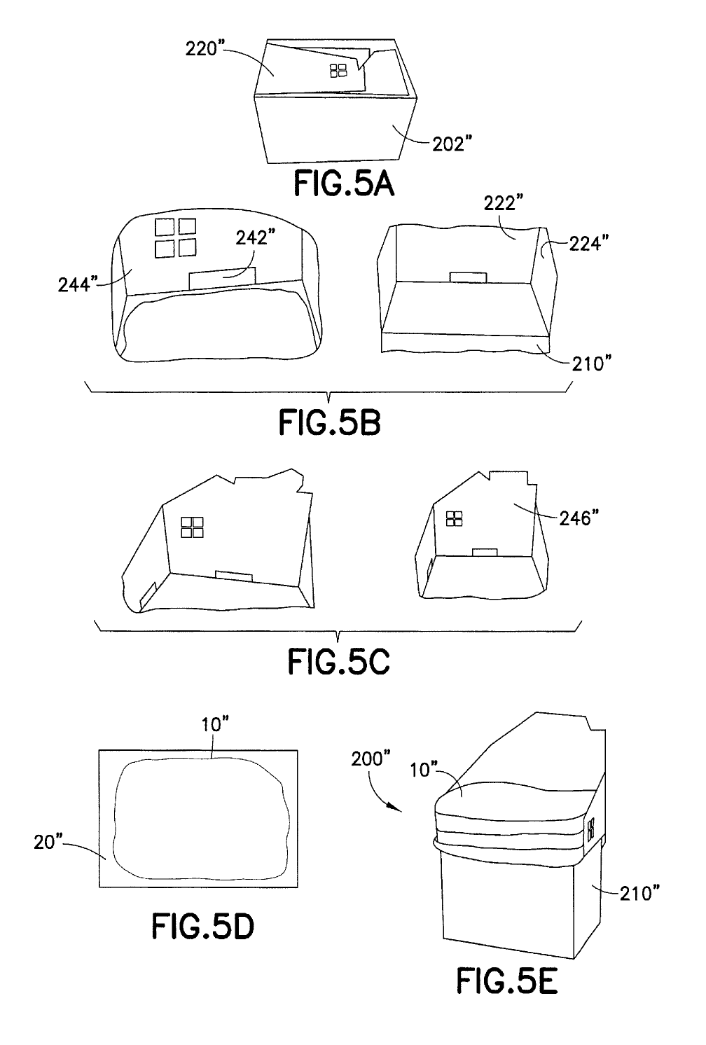

FIG. 5 illustrates a method of assembling a display system 200″ in accordance with another embodiment of the invention. The top of box 200″ is preferably removed, thus exposing display portion 220″. A rear panel 222″ and side panels 224″ each can include a plurality of tabs arranged adjacent to one another. In the embodiment shown, each panel 222″, 224″ includes three tabs, more specifically, one middle tab 242″ located between two end tabs 244″.

Panels 222″, 224″ are preferably placed above container portion 210″ as shown in FIG. 5E, such that adjacent tabs 242″, 244″ are positioned on opposite sides of the respective wall of container portion 210″ on which panels 222″, 224″ are placed. Referring to FIG. 5D, end tabs 244″ can be positioned inside container portion 210″ of box 202″ and middle tab 242″ can be positioned outside container portion 210″, such that display portion 220″ straddles container portion 210″.

Rear panel 222″ can include a top panel 246″ that can be folded away from container portion 210″ until top panel 246″ is aligned with rear panel 222″. As shown in FIG. 5C, rear panel 222″ can resemble a wall of a house, and top panel 246 can resemble a roof, thereby depicting a home or part of a home where the stored displayed products will be used.

Preferably, a plurality of products are provided within box 202″ that can be removed from their packaging and thereafter displayed in display system 200″. Referring to FIGS. 5D and 5E, the product can be sealed, such as a pet bed 10″ whose volume is reduced by packaging 20″ to maximize the number of products that can be included in each box 202″. For example, one, two, three or more pet beds 10″ can be compressed and vacuum-sealed in a single bag 20″. One or more bags 20″ can be cut or otherwise opened and the pet beds 10″ can be removed therefrom. One or more bags 20″ of pet beds 10′ are preferably kept in other bags 20″ and within container portion 210″.

Referring to FIG. 5E, the removed and uncompressed pet beds 10″ are preferably fluffed and placed above pet beds 10″ remaining in bags 20″ in container portion 210″. The fluffed pet beds 10″ can be arranged as desired, for example, in alternating colors, patterns, etc. When desired, for example when all the fluffed pet beds 10″ have been purchased or otherwise removed from display system 200″, additional pet beds 10″ can be removed from within container portion 210″ and displayed. Additional pet beds 10″ or other products can be placed in container portion 210″ for the desired height for displaying the fluffed pet beds 10 thereabove.

An embodiment of the system 300 in accordance with the invention can be provided as a kit, wherein all the components are included within the same box and an instruction sheet for assembling, arranging, etc. the system is provided. The instructions can be provided in the form of a pamphlet, on the side of a box, on a card, etc.

Alternatively, one or more of the top flaps can be used as the display section without rather than a separate display section.

The example provided and the numbered elements are merely exemplary, as a matter of application specific to design choice, and should not be construed to limit the scope of the invention in any way. Thus, while there have been shown and described and pointed out novel features of the present invention as applied to preferred embodiments thereof with reference to the drawings, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

What is claimed is:

1. A method of marketing products comprising:
individually packaging a plurality of products and placing them in a box, the box including a display portion constructed and arranged to be configured into a display configuration;
shipping the box to a retail location comprising a customer access area;
arranging the display portion into its display configuration in relation to the box, removing some, but not all of the individually packaged products from the box, and removing them from their individual packaging;
arranging the products that were removed from their individual packaging on the display portion, wherein the box is located in the customer access area;
as products are removed from the display portion, removing additional products from the box, removing them from their individual packaging and placing them on the display portion; and
when all of the products are gone from the box and the display portion, removing the box and display portion from the customer access area.

2. The method of claim 1, wherein these products are in a compressed state of less than about 50% of their uncompressed volume and the products are put in their uncompressed state on the display area.

3. The method of claim 2, wherein the products comprise pet beds and the display area depicts at least a portion of a house.

4. The method of claim 1, wherein the box and display portion are made of cardboard.

5. A method of transporting and displaying a product, the method comprising:
providing a plurality of products in a container having a receptacle suitable for housing the plurality of products;
transporting the plurality of products in the container;
opening the container;
removing a display assembly from within the container;
arranging the display assembly above the receptacle to display some of the products on the assembly while other products from the container remain in the container.

6. The method of claim 5, wherein opening the container includes folding a plurality of flaps and adhering the flaps to respective walls of the receptacle.

7. The method of claim 5, further comprising adhering the display assembly to the receptacle.

8. The method of claim 5, further comprising inserting one or more tabs connected to the display assembly into one or more slots provided in the receptacle.

9. The method of claim 5, wherein the display assembly is provided in a kit including a written indication of the method of arranging the display assembly.

10. A display system comprising:
a container for shipping a plurality of items, the container having
a receptacle constructed and arranged to house the items, and
a plurality of flaps or panels;
a display assembly provided within the receptacle, the display assembly defining a display area suitable for displaying one or more of the items, wherein the remaining items can be maintained in the receptacle;
wherein the display assembly includes a graphic display.

11. The display system of claim 10, wherein the display assembly is attached to the receptacle with adhesive or by inserting tabs into slots.

12. The display system of claim 10, wherein the display assembly is detachable from the receptacle.

13. The display system of claim 10, wherein the one or more of the items being displayed are in a decompressed state and the remaining items are in a compressed state.

14. The display system of claim 13, wherein the items are pet beds and the display portion depicts a home or a portion of a home.

15. The display system of claim 10, wherein the display assembly includes a plurality of panels connectable to the receptacle.

16. The display system of claim 10, wherein the panels include instructions for arranging the panels with respect to the receptacle.

17. A display system comprising:
a container for shipping a plurality of items, the container having a receptacle constructed and arranged to house the items; and
a display assembly provided within the receptacle, the display assembly defining a display area suitable for displaying one or more of the items above the receptacle;
wherein the display assembly includes a graphic display.

18. The display system of claim 17, wherein the container includes removable flaps which can be removed after opening the container.

19. The display system of claim 17, further comprising connection mechanisms constructed and arranged to connect the display assembly to the receptacle.

20. The display system of claim 17, wherein the receptacle includes one or more slots and the display assembly includes one or more tabs constructed and arranged to be inserted into the one or more slots.
